(19) United States
(12) Patent Application Publication
(10) Pub. No.: US 2023/0390719 A1
(43) Pub. Date: Dec. 7, 2023

(54) LOW PRESSURE JET NOZZLE AND OPTIMIZED JET PATTERN FOR MIXING PROCESS WATER IN CRUDE OIL

(71) Applicant: Sensia Netherlands B.V., Rotterdam (NL)

(72) Inventors: Stuart Fraser Wright, Battle (GB); Stephen Rollings, Richmond, TX (US)

(73) Assignee: Sensia Netherlands B.V., Rotterdam (NL)

(21) Appl. No.: 17/833,413

(22) Filed: Jun. 6, 2022

(51) Int. Cl. B01F 25/313; B01F 25/20

(52) U.S. Cl. CPC B01F 25/31331; B01F 25/28; B01F 2101/40

(57) ABSTRACT

Systems and methods provided herein relate to a fluid mixing device for a pipeline. The pipeline includes a pipe wall and a first axial bore that extends from an inlet of the pipeline to an outlet of the pipeline for conveying a pipeline fluid through the pipeline from the inlet to the outlet. The fluid mixing device includes a fluid source operable to supply a mixing fluid to the axial bore through one or more orifices fluidly coupled to the fluid source. The one or more orifices include a first orifice. The first orifice includes an intake portion operable to receive the mixing fluid and defining a first interior diameter, a discharge portion operable to discharge the mixing fluid and defining a second interior diameter smaller than the first interior diameter, and a taper portion intermediate the intake portion and the outlet portion.

### BACKGROUND

The present disclosure relates to the fluid mixing devices. More specifically, the present disclosure relates to jet mixers for fluid mixing devices.

In order to meet consumer and industrial demand for natural resources, companies often invest significant amounts of time and money in finding and extracting oil, natural gas, and other subterranean resources from the earth. Particularly, once desired subterranean resources such as oil or natural gas are discovered, drilling and production systems are often used to access and extract the resources. These systems may be located onshore or offshore depending on the locations of the desired resources. Once extracted, the resources are often transported via pipelines to desired locations, such as refineries.

Pipelines often convey multiple fluids simultaneously. For instance, flowing oil, water, and gas can be present in different proportions at a given location in the pipeline. In such cases, the fluid is often referred to as a multiphase fluid that includes individual phases of oil, water, and gas. Particulates, such as sand or sediment, may also be carried by the multiphase fluid. The fluid traveling through the pipeline can be analyzed to determine characteristics of the fluid. Such analysis can be performed in situ at the pipeline or on samples collected from the pipeline for future analysis, such as in a laboratory. Determined characteristics of fluid flowing through the pipeline may be used in various manners, such as to facilitate custody transfer of hydrocarbon fluids, auditing, taxation, and quality management.

Some designs of pipelines feature a fluid mixing device to agitate and mix the fluid flowing through the pipeline in order to facilitate the analysis of the fluid flowing through the pipeline.

### SUMMARY

One implementation of the present disclosure relates to a fluid mixing device for a pipeline. The pipeline includes a pipe wall and a first axial bore that extends from an inlet of the pipeline to an outlet of the pipeline for conveying a pipeline fluid through the pipeline from the inlet to the outlet. The fluid mixing device includes a fluid source operable to supply a mixing fluid to the axial bore through one or more orifices fluidly coupled to the fluid source. The one or more orifices including a first orifice. The first orifice includes an intake portion operable to receive the mixing fluid and defining a first interior diameter, a discharge portion operable to discharge the mixing fluid and defining a second interior diameter smaller than the first interior diameter, and a taper portion intermediate the intake portion and the outlet portion.

Another embodiment of the present disclosure relates to an apparatus including a conduit having a bore for conveying a multiphase fluid extending from an inlet of the conduit to an outlet of the conduit, an external pump, and a hollow annular insert extending at least partially into the conduit. The hollow annular insert includes an insert wall enclosing a insert bore in fluid communication with an insert inlet, and a number of ducts disposed within the insert wall, such that the insert bore is in fluid communication with the conduit via the number of ducts. The number of ducts each include an intake portion operable to receive a process fluid from the insert bore and defining a first interior diameter and a discharge portion operable to discharge the process fluid and defining an annular bore forming a second interior diameter smaller than the first interior diameter. The annular bore is operable to form a flow of the process fluid into a fluid column. Each of the number of ducts further include a taper portion intermediate the intake portion and the discharge portion. The taper portion defines a third internal diameter decreasing from a first end of the taper portion coupled to the intake portion to a second end of the taper portion coupled to the discharge portion, such that the flow of the process fluid is accelerated between the intake portion and the discharge portion.

Yet another embodiment of the present disclosure relates to a method. The method includes routing a multiphase fluid into a pipe of a fluid mixing device, the pipe having a pipe wall and an axial bore that extends from an inlet of the pipe to an outlet of the pipe for conveying the multiphase fluid through the pipe from the inlet of the pipe to the outlet of the pipe. The fluid mixing device further includes a sleeve disposed about the pipe and a cavity provided between an exterior surface of the pipe and an interior surface of the sleeve. The cavity and the axial bore of the pipe are in fluid communication with one another via a number of openings through the pipe wall. The number of openings through the pipe wall are located between the inlet of the pipe and the outlet of the pipe. The number of openings each include an intake portion operable to receive a mixing fluid from the cavity and defining a first interior diameter and a discharge portion defining an annular bore forming a second interior diameter smaller than the first interior diameter. The annular bore is operable to form a flow of the external fluid into a fluid column. Each of the number of openings further include a taper portion intermediate the intake portion and the discharge portion, the taper portion defining a third internal diameter decreasing from a first end of the taper portion coupled to the intake portion to a second end of the taper portion coupled to the discharge portion, such that the flow of the external fluid is accelerated between the intake portion and the discharge portion. The method further includes routing a mixing fluid into through the cavity and into the intake portions of the number of openings via an external pump fluidly coupled to an inlet of the cavity and jetting the mixing fluid directly into the pipe via the discharge portions of the number of openings to mix components of the multiphase fluid with one another. The mixing fluid is accelerated along the taper portion and formed into a fluid column by the annular bore of the discharge portion.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a fluid sampling system with a fluid mixing device, according to some embodiments.

FIG. 2 is a partial front view of a nozzle-based configuration of jet orifices, which can be implemented in the fluid mixing device of FIG. 1, according to some embodiments.

FIG. 3 is partial cross-sectional view of a nozzle-based configuration of jet orifices, which can be implemented in the fluid mixing device of FIG. 1, according to some embodiments.

FIG. 4 is a cross-sectional view of a jet orifice, which can be implemented in the fluid mixing device of FIG. 1, according to some embodiments.

FIG. 5 is a cross-sectional view of an angled jet orifice, which can be implemented in the fluid mixing device of FIG. 1, according to some embodiments.

FIG. 6 is a cross-sectional view of a wall-based configuration of jet orifices, which can be implemented as a fluid mixing device in the fluid sampling system of FIG. 1, according to some embodiments.

FIG. 7 is a cross-sectional view of a wall-based configuration of jet orifices arranged in multiple rows, which can be implemented as a fluid mixing device in the fluid sampling system of FIG. 1, according to some embodiments.

FIG. 8 is a cross-sectional view of a wall-based configuration of jet orifices arranged in multiple bi-directional rows, which can be implemented as a fluid mixing device in the fluid sampling system of FIG. 1, according to some embodiments.

FIG. 9 is a cross-sectional view of a wall-based configuration of jet orifices arranged in a ring, which can be implemented as a fluid mixing device in the fluid sampling system of FIG. 1, according to some embodiments.

### DETAILED DESCRIPTION

### Overview

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to fluid mixing devices, including, but not limited to, fluid mixing devices for jetting a mixing fluid into a resource fluid (e.g., crude oil, a pipeline fluid, a multiphase fluid, fuel oil, etc.) flowing through a main line (e.g., a tube, a pipeline, a conduit, a main process pipeline, etc.). In some embodiments, the mixing fluid is a process fluid, such as water or some other acceptable fluid. In other embodiments, the mixing fluid is the resource fluid, extracted from the main line at a downstream point in the main line and resupplied (e.g., reinjected) to an upstream point in the main line as the mixing fluid. The mixing fluid may be miscible (i.e., forming a homogeneous mixture) or immiscible (i.e., not forming a homogeneous mixture). In some embodiments, the mixing fluid is dispersed into the flow of the resource fluid at a point along the main line to agitate and mix the resource fluid before the resource fluid reaches a fluid sampling system configured to analyze the composition of the resource fluid. Accordingly, in some embodiments, the sampling system may then be used to extract a representative sample of the resource fluid (mixed with the mixing fluid, in some cases). In some embodiments, the resource fluid is crude oil and may be a multi-phase fluid (e.g., a fluid including oil, water, gas, or some other appropriate fluid). Accordingly, the representative sample may have a water fraction that is representative of the entire batch (e.g., the resource fluid flowing through the main line at a particular instance or period of time), thereby allowing the overall water fraction of the batch to be established.

Accordingly, embodiments of the present disclosure generally relate to the mixing of fluids flowing through main lines. In certain embodiments, an apparatus includes a device that injects a mixing fluid into a pipe to agitate and mix fluid that is flowing through the pipe. In at least some instances, the mixing fluid is drawn from the pipe and then returned back into the pipe to mix the flowing fluid. In some embodiments, the fluid mixing device can include a nozzle inserted into the main line. Mixing fluid is pumped into the nozzle and is routed through the nozzle into the pipe as fluid jets through openings in the wall of the nozzle. In other embodiments, the fluid mixing device can include a sleeve positioned about the pipe. Mixing fluid is pumped into a cavity within the sleeve and is routed from the cavity into the pipe as fluid jets through openings in the wall of the pipe.

In some embodiments, and as suggested above, a fluid mixing device injects the mixing fluid into the main line through one or more jets. Such jets may be an orifice (e.g., a channel, an aperture, an opening, a hole, etc.) in fluid communication with a pump. The jets may discharge a mixing fluid into the main line to create sufficient turbulence (e.g., mixing, disruption, agitation, etc.) in the resource fluid flowing through the main line. Such turbulence may sufficiently mix the resource fluid such that the various liquid phases of the resource fluid (e.g., oil, water, gas, some other fluid, etc.) are substantially evenly distributed throughout at least a portion of the main line. Accordingly, the portion of the main line that is substantially evenly distributed may be analyzed via the sampling system by extracting a sample of the process fluid for analysis. For example, without sufficient mixing, the extracted sample may include a disproportionate amount of oil, water, gas, or some other fluid that is not representative of the entirety of the resource fluid flowing through the main line.

In some embodiments, in order to perform the desired mixing, a pump is used to apply a pressure to the process fluid such that the process fluid is forced through the jets at high velocities to provide sufficient turbulence for the fluid mixing described herein. Accordingly, the velocity required to provide sufficient turbulence may be proportional to an amount of the pressure required to be supplied by the pump (e.g., a pressure drop across the pump). In some designs, there may be a high capital cost associated with operating a pump to supply the sufficient amount of pressure. Such costs may be associated with larger pumps, motors, piping, and associated equipment. Furthermore, large pumps and motors have high running costs. Accordingly, it would be advantageous to provide a jet that is configured to minimize the amount of pressure required to accomplish the desired mixing of the resource fluid, thereby minimizing the costs associated with the pressure drop required to provide sufficient turbulence. Through reducing the required pressure drop, the sizes and running costs of the various components involved in generating the pressure drop can be reduced. In some embodiments, a jet may be configured to feature a wide inlet, a taper, and an outlet that allows fluid to enter the inlet at a first velocity, accelerate through the taper, and be discharged through the outlet at a higher velocity, thus minimizing the amount of pressure required to be supplied by the pump to accomplish the fluid mixing described herein. Further, in some embodiments, the outlet of the jet is configured to form the accelerated fluid into a fluid column (e.g., the accelerated fluid is collimated), thus providing improved fluid mixing due to the targeted column of fluid discharged. Such fluid collimation may further minimize the amount of pressure required to be supplied by the pump due to the functional improvements of fluid mixing associated with the discharge of a fluid column (as opposed to a dispersed spray, for example).

While the present disclosure is generally described herein in relation to fluid mixing systems for resource fluids flowing through pipelines, it should be understood that the present disclosure may be applied to other fluid mixing equipment using jets where it is desirable to minimize pressure drop across a pump in fluid communication with the jets.

Fluid Sampling System with Mixing Device

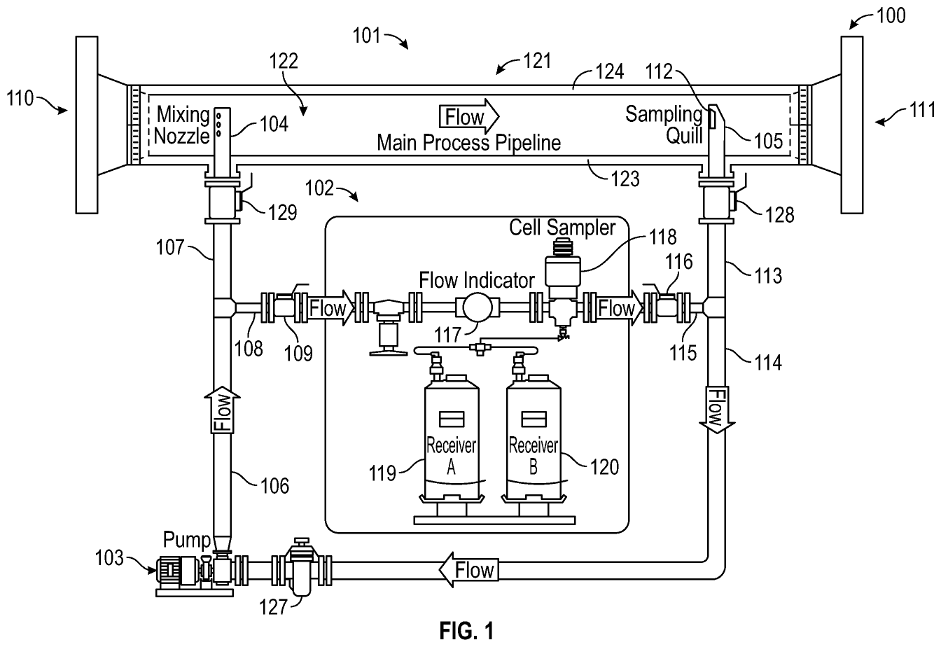

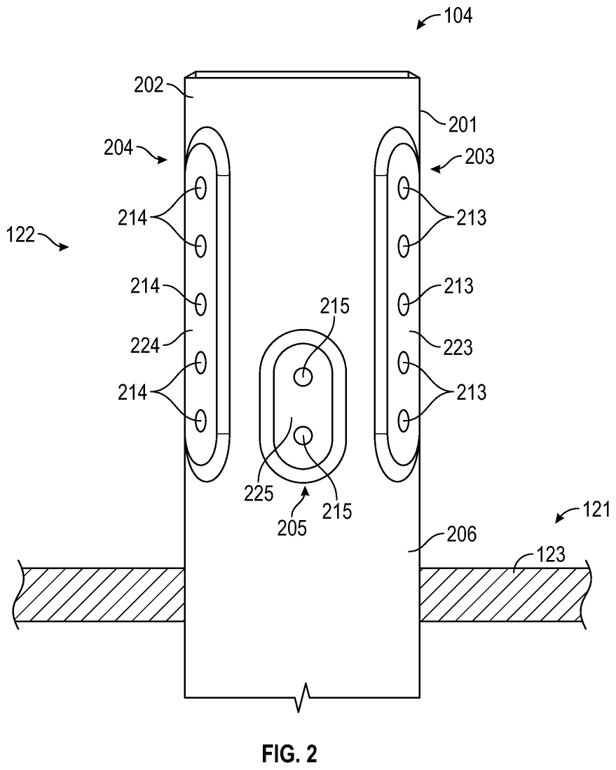

Referring now to FIG. 1, a schematic of a fluid sampling system 100 is shown, according to some embodiments. In some embodiments, the fluid sampling system 100 includes a main line 101, an analysis subsystem 102, and a pump 103. In some embodiments, and as shown, the main line 101 is installed horizontally. In other embodiments, however, the main line 101 is installed vertically or at various angles. The main line 101 may include a pipe wall 121 surrounding an axial bore 122 extending from an inlet 110 to an outlet 111. A resource fluid may flow from through the axial bore 122 from the inlet 110 to the outlet 111. The sampling system may further include a nozzle 104 and a sampling quill 105. The nozzle 104 may include one or more orifices (e.g., jets, openings, apertures, etc.) configured to discharge a mixing fluid received in an axial bore within the nozzle 104 into the main line 101. In some embodiments, the mixing fluid is the resource fluid, recirculated through the fluid sampling system 100, as generally depicted in FIG. 1. In other embodiments, however, the mixing fluid is drawn from an external source. In this sense, the mixing fluid may be a different fluid than the resource fluid, such as water or any other suitable fluid. Thus, as used herein, “mixing fluid” refers to the particular fluid being discharged into the axial bore 122 to agitate the resource fluid flowing through the main line 101, although the mixing fluid itself may, in some embodiments, be the resource fluid after being recirculated through the fluid sampling system 100 as shown. The one or more orifices are described in greater detail below with reference to FIGS. 2-5. The pump 103 may be fluidly coupled to the nozzle 104 by a first pipe segment 106 and a second pipe segment 107. Further, in some embodiments, the pump 103 is in selective fluid communication with the nozzle 104 via a first isolation valve 129. The pump 103 may be configured to provide a pressure to the mixing fluid, such that the mixing fluid flows through the first pipe segment 106, the second pipe segment 107, the nozzle 104, and into the main line 101. The pump may facilitate a flow of the mixing fluid to the analysis subsystem 102 via the first pipe segment 106 and a third pipe segment 108. The flow of mixing fluid into the analysis subsystem 102 via the third pipe segment 108 may be selectively allowed by a second isolation valve 109.

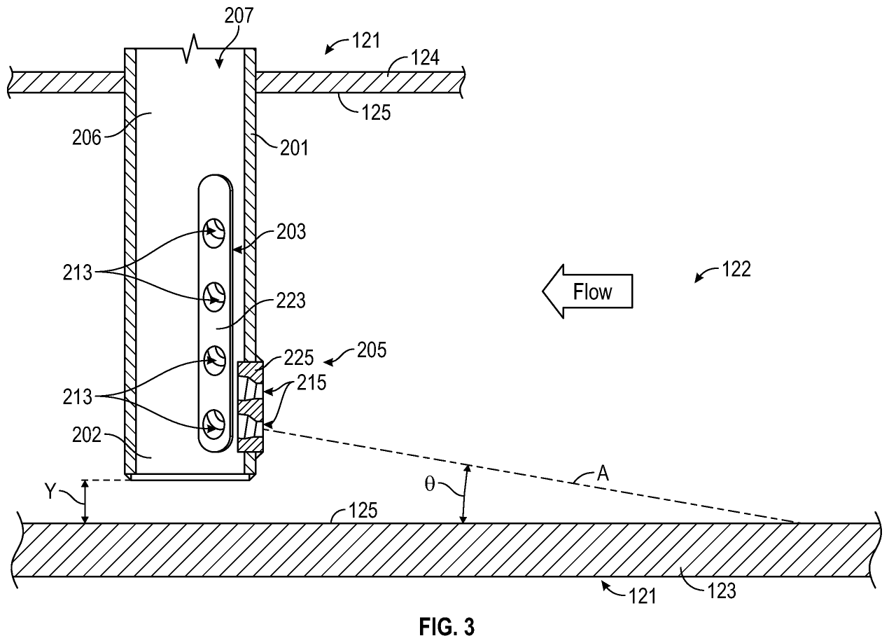

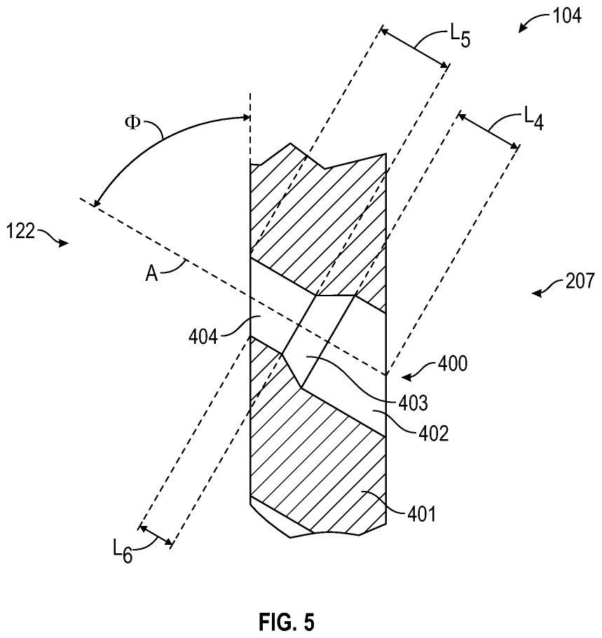

In some embodiments, and as shown, the nozzle 104 is disposed within the pipe wall 121 of the main line 101 such that the nozzle 104 extends into the axial bore 122 in a bottom-up fashion. In other words, the nozzle 104 may extend through a lower portion 123 of the pipe wall 121. Such an arrangement is depicted in greater detail with reference to FIG. 2. However, in other embodiments, the nozzle 104 may be disposed within an upper portion 124 of the pipe wall 121 such that the nozzle 104 extends into the main line axial bore 122 in a top-down fashion. Such an arrangement is depicted in greater detail with reference to FIG. 3. Further, the nozzle 104 may be disposed within any circumferential location of the pipe wall 121 that facilitates the mixing processes described herein. Depending on the implementation, and to accomplish the advantageous properties of the fluid sampling system 100 described herein, the nozzle 104 may feature various arrangements and orientations of the one or more orifices, as described in greater detail below with reference to FIGS. 2 and 3. In other embodiments, the fluid sampling system 100 does not necessarily include the nozzle 104 and/or the sampling quill 105. Rather, the one or more orifices depicted on the nozzle 104 may be directly disposed within the pipe wall 121 to discharge the mixing fluid into the axial bore 122 without a need to extend a nozzle, such as the nozzle 104, into the axial bore 122. The sampling quill 105 may be similarly replaced by orifices configured to draw the resource fluid from the axial bore 122. For example, in small diameter pipelines (i.e., pipelines with an inner diameter of no more than six inches), structures such as the nozzle 104 and the sampling quill 105 extending into the axial bore 122 for drawing fluid from or returning fluid to the main line 101 could cause an undesirable pressure drop in the fluid. Accordingly, in at least some embodiments, the fluid sampling system 100 does not include any nozzles, probes, or other structures extending into the axial bore 122 for drawing fluid from or injecting fluid into the main line 101. Such arrangements, at least with respect to replacing the nozzle 104 with orifices disposed within the pipe wall 121, are depicted in greater detail with reference to FIGS. 5-8. However, in other instances, such as with larger pipelines, structures such as the nozzle 104 and the sampling quill 105 may be inserted into the main line 101 as depicted.

In some embodiments, the analysis subsystem 102 receives a flow of the resource fluid (forced by the pump 103, in some embodiments) via the third pipe segment 108, which may be selectively allowed by the second isolation valve 109. In some embodiments, the resource fluid received by the analysis subsystem is the resource fluid captured by the aperture 112 of the sampling quill 105 (and thus, resource fluid that has been mixed by interaction with the mixing fluid). The flow of resource fluid entering the analysis subsystem 102 via the third pipe segment 108 may flow through a flow indicator 117 and a cell sampler 118. The cell sampler 118 may be in communication with a first analysis receiver 119 and a second analysis receiver 120 in order to determine various properties of the resource fluid (e.g., a water fraction, an oil fraction, a gas fraction, chemical properties of the various fluids, and so on). In some embodiments, additional analysis receivers may be included in the analysis subsystem 102 to determine the various properties of the resource fluid. Using the flow indicator 117 and the cell sampler 118, the analysis subsystem 102 may determine the properties of the resource fluid flowing through the main line 101. In some embodiments, and as disclosed herein, the operation and measurements of the analysis subsystem 102 is optimized by receiving a resource fluid that has been mixed by the mixing fluid.

In some embodiments, the mixing of the resource fluid upstream of the sampling quill 105 can be performed to ensure that the portion of the resource fluid to be analyzed (e.g., the portion of the resource fluid captured by the aperture 112 of the sampling quill 105) is representative of the resource fluid as a whole. More specifically, the resource fluid can be mixed in the main line 101 to ensure that the portion of the resource fluid captured by (e.g., received by, drawn in by, etc.) the aperture 112 has proportions of individual phases (e.g., of oil and water) that do not meaningfully differ from those in the main line 101 itself. The resource fluid may be discharged (drawn by the pump 103, in some embodiments) from the analysis subsystem 102 via a sixth pipe segment 115, which may be selectively allowed by a fifth isolation valve 116. The resource fluid may then join the resource fluid received by the sampling quill 105 (as described in greater detail below) and flowing through a fourth pipe segment 113 at a fifth pipe segment 114 in order to return to the pump 103, which may be selectively allowed by a sixth isolation valve 127. In some embodiments, the analysis subsystem 102 further includes a density meter, a viscosity meter, pressure and temperature compensation devices, and any other suitable devices required to analyze the resource fluid as described herein.

In some embodiments, the resource fluid may flow through the main line 101 from the inlet 110 to the outlet 111. The nozzle 104 may be disposed within the main line 101 at a point in between the inlet 110 and the outlet 111 such that the orifices of the nozzle 104 are in fluid communication with the resource fluid flowing through the main line 101. The sampling quill 105 may be disposed within the main line 101 at a point in between the nozzle 104 and the outlet 111. The sampling quill may include an aperture 112 configured to collect a sample of the resource fluid (mixed by, and potentially including, the mixing fluid) to be routed back to the pump 103 via the fourth pipe segment 113 and a fifth pipe segment 114. In some embodiments, such collection is accomplished by the pump 103 drawing fluid through the aperture 112 and through the fourth pipe segment 113 and the fifth pipe segment 114. The mixed resource fluid being routed back to the pump 103 may be joined by a flow of resource fluid leaving the analysis subsystem 102 via the sixth pipe segment 115, as suggested above. The resource fluid flowing through the fifth pipe segment 114 may then return to the pump 103 to be routed back into the first pipe segment 106.

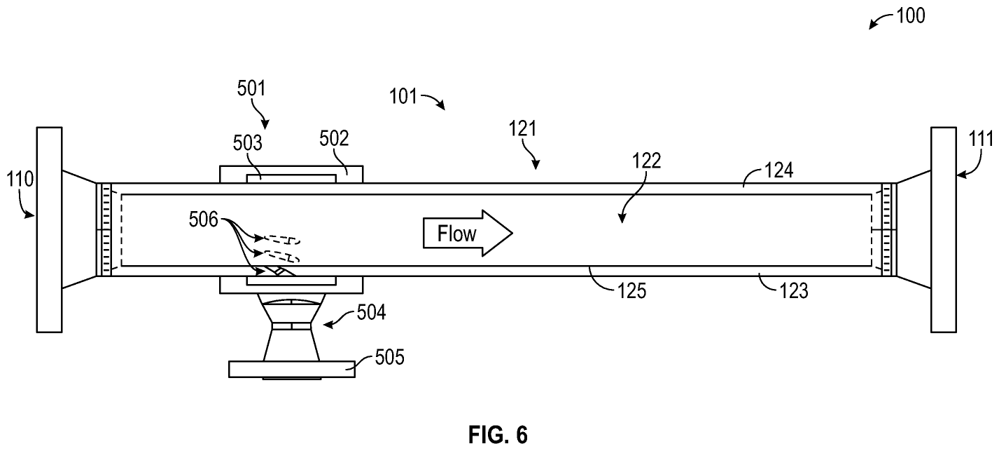

In some embodiments, various components of the fluid sampling system 100 may be included in, or considered as, a fluid mixing device. For example, a fluid mixing device may include any of the nozzle 104, the main line 101, the pump 103, and so on, insofar as components of the fluid sampling system 100 are required for the process of agitating the resource fluid flowing through the main line 101. Further, as suggested above and depicted below with reference to FIGS. 6-9, a fluid mixing device may include various orifices disposed within the pipe wall 121. Such a fluid mixing device may interact with the analysis subsystem 102 or any of the other components of the fluid sampling system 100 described herein.

### Fluid Mixing Device Nozzle

Referring now to FIG. 2, a front view of a nozzle, such as the nozzle 104, is shown, according to some embodiments. As depicted, the nozzle 104 is arranged such that it may be disposed within the lower portion 123 of the pipe wall 121 such that the nozzle 104 extends into the axial bore 122 in a bottom-up fashion. The nozzle 104 may include a nozzle body 201, a distal end 202, and a proximal end 206. The nozzle 104 may include a first orifice arrangement 203, a second orifice arrangement 204, and a third orifice arrangement 205. In some embodiments, the first, second, and third orifice arrangements 203, 204, and 205 may be arranged in parallel arrangements as depicted. In other embodiments, the first, second, and third orifice arrangements 203, 204, and 205 may be arranged in any other acceptable configuration relative to one another in order to perform the fluid mixing methods disclosed herein. For example, one or more of the first, second, and third orifice arrangements 203, 204, and 205 may be distributed in an array (e,g, two-by-two, three-by-three, etc.) as opposed to a series as depicted. As another example, the first, second, and third orifice arrangements 203, 204, and 205 may not be arranged in parallel with respect to one another. In some arrangements, the third orifice arrangement 205 may be considered a “front” set of orifices, and the first and second orifices arrangements 204 and 205 may be considered “side” sets of orifices. In this sense, the nozzle 104 may be arranged within the pipe wall 121 such that the front set of orifices, depicted as the third orifice arrangement 205, may face the inlet 110, such that mixing fluid discharged from the third orifice arrangement 205 is jetted (e.g., directed, forced, injected, etc.) against a direction of flow of the resource fluid. Such an arrangement is depicted in greater detail in FIG. 3. In some embodiment, the first second, and third orifice arrangements 203, 204, and 205, include orifices 213, 214, and 215 (respectively). The first, second, and third orifice arrangements 203, 204, and 205, may include a first, second, and third orifice pad 223, 224, and 225 to facilitate coupling the orifices 213, 214, and 215 to the nozzle body 201 (respectively). In some arrangements, the first, second, and third orifice pads 223, 224, and 225 substantially form the orifices 213, 214, and 215 (respectively). In some arrangements, the first, second, and third orifice arrangements 203, 204, and 205 are made of the same material as the nozzle body 201, such that the entire nozzle 104 may be constructed as a single piece. In other arrangements, the first, second, and third orifice arrangements 203, 204, and 205 are constructed separately from the nozzle 104 such that the first, second, and third orifice arrangements 203, 204, and 205 may be welded to the nozzle body 201 in order to construct the completed nozzle 104.

In some embodiments, and as shown, the third orifice arrangement 205 may include a different number of orifices than the first and second orifice arrangements 203 and 204. For example, the third orifice arrangement 205 may include three orifices 215, while the first and second orifice arrangements 203 and 204 may each include five orifices 213 and 214 (respectively). In various embodiments, the first, second, and third orifice arrangements 203, 204, and 205 may include more or less orifices than what is depicted herein. Moreover, while the third orifice arrangement 205 is shown as including less orifices than the first and second orifice arrangements 203 and 204, in some embodiments, the third orifice arrangement may include the same amount or more orifices than the first and second orifice arrangements 203 and 204. In some embodiments, the number of orifices included in the first, second and third orifice arrangements 203, 204, and 205 may vary depending on a size of the main line 101. For example, the fluid sampling system 100 may include the main line 101 with a larger or smaller pipeline diameter. In cases where the main line 101 has a larger diameter, the first, second, and third orifice arrangements 203, 204, and 205 may include a greater number of orifices and, in various arrangements, the nozzle 104 would accordingly be longer. In other cases, where the main line 101 has a smaller diameter, the first, second, and third orifice arrangements 203, 204, and 205 may include a smaller number orifices and, in various arrangements, the nozzle 104 would accordingly be shorter. In some embodiments, with variations of the diameter of the main line 101, the number of orifices included in the first, second, and third orifice arrangements 203, 204, and 205 may increase or decrease, but maintain a general ratio of orifices relative to one another. For example, as shown, the third orifice arrangement 205 may include a number of orifices (shown as the orifices 215) at a two-to-five ratio to the number of orifices (shown as the orifices 213 and 214) included in the first and second orifice arrangements 203 and 204 (respectively). In other embodiments, other acceptable ratios, such as a one-to-five, two-to-five, four-to-five, one-to-one, five-to-four, and so on, may be used. Further, the orifices 213, 214, and 215 may vary in size or dimension.

As suggested above, the size, shape, number, and arrangement of the orifices 213, 214, and 215 may be varied between different embodiments. The features of the orifices 213, 214, and 215 can be chosen based on the diameter of the pipe wall 121, the orientation of the pipe wall 121 (e.g., for horizontal or vertical flow), the characteristics of the resource fluid expected to be mixed within the main line 101 (e.g., viscosity, density, phase fractions, or amount of particulates), or operating characteristics of the pump 103, to name but a few examples. Although the orifices 213, 214, and 215 could be provided radially through the nozzle body 201 as generally depicted in FIG. 2, the orifices 213, 214, and 215 may be formed at an angle through the nozzle body 201 (i.e., the axis of the orifices 213, 214, and 215 is not perpendicular to the central axis of the nozzle body 201), as depicted below with reference to FIG. 3. Alternatively, at least some of the orifices 213, 214, and 215 could be formed at angles that differ from one another. Still further, the dimensions of each of the orifices 213, 214, and 215 may be identical to one another or may differ.

In some embodiments, and as shown, the third orifice arrangement 205 may be positioned (e.g., offset, located, etc.) relative to the first and second orifice arrangements 203 and 204 such that lower ends 233, 234, and 235 of the first, second, and third orifice arrangements 203, 204, and 205 (respectively) are substantially equidistant with respect to the proximal end 206 of the nozzle 104. In various arrangements, the first, second, and third orifice arrangements 203, 204, and 205 may be located relative to one another (as shown) in order to facilitate a particular configuration of mixing fluid being discharged from the orifices 213, 214, and 215. For example, as suggested above, the third orifice arrangement 205 may be a “front” set of orifices. This is to say that, in some embodiments, the third orifice arrangement 205 discharges mixing fluids against the flow of resource fluid flowing form the inlet 110 to the outlet 111 of the main line 101. As such, the third orifice arrangement 205 may be located on the nozzle 104 (or, in other words, the nozzle 104 may be oriented) such that the orifices 215 generally face the inlet 110. As described in greater detail below with reference to FIG. 2, the orifices 215 may be vertically directed (e.g., up towards the upper portion 124 of the pipe wall 121 or down towards the lower portion 123 of the pipe wall 121) to facilitate the fluid mixing processes disclosed herein. For example, as suggested above, the first, second, and third orifice arrangements 203, 204, and 205, may be configured on the nozzle 104 as shown in FIG. 2 because the nozzle 104 is inserted into the main line 101 in a bottom-up arrangement (through the lower portion 123 of the pipe wall 121). In some implementations, the axial bore 122 may not be entirely full of the resource fluid flowing through the main line 101, and accordingly the resource fluid may travel substantially along the lower portion 123 of the pipe wall 121. In other implementations, the resource fluid may settle (at least to an extent during fluid flow), such that, due to the multi-phase nature of the resource fluid (in some cases) flowing through the main line 101, the particular fluids with greater densities travel substantially along the lower portion 123 of the pipe wall 121. Therefore, for these functional reasons and others, the orifices 215 may be advantageously directed downward toward the lower portion 123 of the pipe wall 121. By directing mixing fluid downward and against the flow of resource fluid, the resource fluid (comingled with the mixing fluid) may experience a turbulence that drives the higher-density fluids upwards within the flow of resource fluid and mixes the higher-density fluids with the lower-density fluids flowing substantially above the higher-density fluids within the general flow of the resource fluid. In some embodiments, the orifices 213 and 214 may be directed upward in order to facilitate sufficient mixing through a vertical distribution of resource fluid flowing through the main line 101. For example, by directing mixing fluid upwards through the orifices 213 and 214, the fluid turbulence incurred via the mixing fluids discharged from the orifices 213 and 214 may interact with the turbulence incurred via the mixing fluids discharged from the orifices 215 to result in an overall turbulence to result in fluid mixing that results in an advantageous degree of dispersal of the various fluid phases involved in the resource fluid flowing through the main line 101.

In some embodiments, the first and second orifice arrangements 203 and 204 may be laterally offset (e.g., circumferentially, in embodiments where the nozzle 104 is substantially annular) from the third orifice arrangement 205. In some embodiments, the first and second orifice arrangements 203 and 204 may be offset from the third orifice arrangement 205 by the same lateral distance (or circumferential measurement). In other embodiments, the first and second orifice arrangements 203 and 204 may be offset from the third orifice arrangement 205 by different degrees or distances. In some embodiments, and as shown, the first and second orifice arrangements 203 and 204 are offset the third orifice arrangement 205, the first and second orifice arrangements 203 and 204 are offset to a degree that substantially positions the first and second orifice arrangements 203 and 204 on the nozzle 104 such that the orifices 213 and 214 (respectively) are at least partially directed towards the inlet 110 that the orifices 215 are substantially directed towards. For example, the offset may be a radial measure of forty-five degrees, in some embodiments. In this sense, the orifices 213 and 214 are positioned such that they may substantially direct mixing fluid towards the inlet 110, while also directing mixing fluid towards the sides of the main line 101 in order to provide an advantageous distribution of mixing fluid discharge throughout a portion of the main line 101. In other embodiments, the offset may be a radial measure of more or less than forty-five degrees (thirty degrees, ninety degrees, one-hundred and twenty degrees, and so on). In some embodiments, and as suggested above, one or more of the first, second, and/or third orifice arrangements 203, 204, and 205, may be arranged as an array rather than a series (e.g., two-by-two instead of two in a row or series). In such cases, a lateral offset in various embodiments may function the same as described above, but alternatively be determined by a distance between a point on one of the first, second, or third orifice pads 223, 224, or 225, relative to a corresponding point on another one of the first, second, or third orifice pads 223, 224, or 225, such as an edge or a circumferential center point.

Referring now to FIG. 3, a perspective cross-sectional view of a nozzle, such as the nozzle 104, is shown, according to some embodiments. In some embodiments, the nozzle body 201 forms an axial bore 207 (e.g., a nozzle bore) within the nozzle body 201. The mixing fluid may flow into an opening (e.g., an inlet) formed at the proximal end 206 of the nozzle 104, through the axial bore 207, and through the orifices 213, 214, and 215 to be discharged into the resource fluid flowing through the main line 101. As depicted, the nozzle 104 is arranged such that it may be disposed within the upper portion 124 of the pipe wall 121 such that the nozzle 104 extends into the axial bore in a top-down fashion. Compared to the nozzle 104 as depicted in FIG. 2, as shown here, the third orifice arrangement 205 may be located closer to the distal end 202 than in a case where the nozzle 104 is arranged in a bottom-up fashion (as shown in FIG. 2).

As shown in the cross-sectional view of the nozzle 104 depicted, the first, second (not shown), and third pads 223, 224, and 225 may partially protrude radially inward into the axial bore 207 formed within the nozzle body 201 and/or radially outward from the nozzle body 201. In some embodiments, the first, second, and third pads 223, 224, and 225 may protrude as shown to form the orifices 213, 214, and 215 in the case that the nozzle body 201 has a thickness that is less than what may be necessary to form the orifices 213, 214, and 215. In other embodiments, the nozzle body 201 is constructed with a sufficient thickness to form the orifices 213, 214, and 215, such that the first, second, and third pads 223, 224, and 225 are either unnecessary or do not protrude from the nozzle body 201.

In some embodiments, and as suggested above, the orifices 213, 214, and 215 may be directed in various vertical directions to achieve the fluid mixing disclosed herein. As shown, the orifices 215 are directed at least slightly downward. In this sense, with an understanding that the nozzle 104 as depicted in FIG. 3 is configured in a top-down arrangement with respect to the main line 101, the orifices 215 are directed downward in order to be directed towards the lower portion 123 of the pipe wall 121. Accordingly, there may be a distance Y between the distal end 202 of the nozzle 104 and an interior surface 125 of the pipe wall 121 on the lower portion 123, representing a clearance distance between the distal end 202 and the interior surface 125. In some embodiments, Y represents the thickness of a pad that supports the nozzle 104 by resting on the interior surface 125 and providing support to the nozzle 104 via the distal end 202. In other embodiments, Y is substantially zero, in the sense that the nozzle 104 itself rests against the interior surface 125. It follows that the orifices 215 may be oriented downward to the interior surface 125 at an angle Θ formed between a central axis A of one or more of the orifices 215 and the interior surface 125. In some embodiments, Θ is five degrees. In other embodiments, Θ is ten degrees. In other embodiments still, Θ may be any appropriate degree as necessary to direct mixing fluid toward the interior surface 125 of the lower portion 123 of the pipe wall 121 to accomplish the fluid mixing disclosed herein. In some embodiments, all of the orifices 215 are angled through the nozzle body 201 at the same angle (Θ, for example). In other embodiments, the orifices 215 may be angled through the nozzle body 201 to varying degrees. For example, the orifices 215 may be angled through the nozzle body 201 to varying degrees in order to be directed toward substantially the same point along the interior surface 125.

In some embodiments, the orifices 213 and 214 may be directed in a vertical direction that is generally opposite relative to the vertical direction at which the orifices 215 are directed towards. For example, as shown, the orifices 213 are depicted as directed upwards (toward the upper portion 124 of the pipe wall 121. It follows that orifices 213 and 214 may be oriented upward to the interior surface 125 on the upper portion 124. In some embodiments, an angle at which the orifices 213 and 214 are directed upward (not shown) and Θ may substantially equal (e.g., both five degrees, both ten degrees, etc.). In other embodiments, the angle at which the orifices 213 and 214 are directed upward and Θ may be different. Such differences between may generally be attributed to variations in the size (e.g., the diameter) of the pipe wall 121 or the size of the nozzle 104, depending on the implementation of the systems and methods described herein.

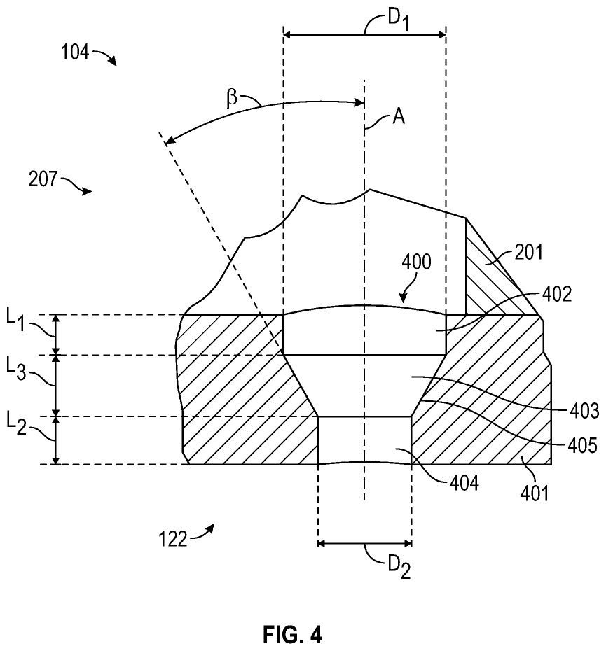

Referring now to FIG. 4, cross-sectional view of an orifice 400 is shown, according to some embodiments. As shown, the orifice 400 may be implemented on the nozzle 104. However, in other embodiments, the orifice 400 may be implemented in various other implementations of a fluid mixing system, as described in greater detail below with reference to FIGS. 6-9. The orifice 400 may be implemented as any of the orifices 213, 214, or 215 described herein. The orifice 400 may be disposed within, or formed by, an orifice pad 401, which may be implemented as any of the first, second, or third orifice pads 223, 224, or 225 described herein. The orifice pad 401 may be coupled to a portion of a nozzle wall, such as the nozzle body 201. The orifice 400 may form a discharge path through which mixing fluid flows from a source region, such as the axial bore 207 of the nozzle 104, and is discharged into main line 101 (in other words, the axial bore 122 within the pipe wall 121). Accordingly, the discharge path of the nozzle 104 may be in fluid communication with the axial bore 207 of the nozzle 104 (and, by extension, the pump 103 described above with reference to FIG. 1) as well as the axial bore 122 of the main line 101.

The discharge path formed by the orifice 400 may include an inlet portion 402, a taper portion 403, and an outlet portion 404 (e.g., a discharge portion of the orifice 400). Accordingly, the discharge path suggested above may flow from the inlet portion 402, through the taper portion 403, and into and through the outlet portion 404 to the axial bore 122 of the main line 101. In some embodiments, the inlet portion 402, the taper portion 403, and the outlet portion 404 may each be substantially annular (e.g., circular) in design. In other embodiments, the inlet portion 402, the taper portion 403, and the outlet portion 404 may be elliptical in nature or form some other cross-sectional geometry that is appropriate for fluid discharge.

In some embodiments, the inlet portion 402 may form a cross-sectional area. For example, where the inlet portion 402 is circular as suggested above, the inlet portion 402 may form a cross-sectional area that is derived from a diameter D₁. Similarly, the outlet portion 404 may form a cross-sectional area that is derived from a diameter Dz. In some embodiments, the area of the inlet portion 402 is greater than the area of the outlet portion 404. In various implementations, the inlet portion 402 may be three times greater than the area of the outlet portion 404, four times greater, five times greater, and so on. The taper portion 403 may connect the inlet portion 402 to the outlet portion 404. In some embodiments, the taper portion 403 may have a smoothly inwardly curving profile as it progresses from the inlet portion 402 to the outlet portion 404, with no steps or angles present on an inner surface 405 of the taper portion 403. Accordingly, a diameter (and, accordingly, a cross-sectional area) of the taper portion 403 may smoothly (e.g., continuously) reduce in the direction of the outlet portion 404. In other embodiments, the taper portion 403 may be formed as a series of angles or steps in order to connect the inlet portion 402 to the outlet portion 404. The taper portion 403 may form an angle β with the central axis A of the discharge path, further depicted with reference to FIG. 3. β may be derived from, or determined in conjunction with, an L₃ of the taper portion 403, D₁, and D₂ in order to construct the orifice 400 to achieve the advantages of the present disclosure.

In some embodiments, the relative values of D₁ and D₂ (e.g., D₁ being greater than D₂) allows the mixing fluid to flow into the discharge path of the orifice 400 at the inlet portion 402 at a first velocity and exit (e.g., be discharged from) the outlet portion 404 of the discharge path at a second greater velocity. In other words, the mixing fluid flowing through the discharge path may be accelerated through the taper portion 403 as the taper portion 403 reduces in diameter (or other applicable dimension, depending on the implementation). Advantageously, by accelerating the mixing fluid through the taper portion 403, less force is required from the pump 103 (in other words, a pressure drop across the pump 103 is reduced). For example, in order to provide the mixing fluid to the inlet portion 402 at a particular velocity, the pump 103 generally must generate a particular amount of force. However, as the cross-sectional area of the taper portion 403 decreases, a pressure within the mixing fluid flowing through the taper portion 403 increases due to the reduction in the cross-sectional area while the mass flow of the fluid flowing through the discharge path of the orifice 400 remains substantially the same throughout. Such an increase in pressure, resulting from the dimensions of the taper portion 403, facilitates an increase in a velocity of the mixing fluid discharged from the orifice 400 that, accordingly, does not need to be enacted directly by the pump 103. By reducing the amount of force required by (or pressure drop across) the pump 103, the various advantages related to energy-efficiency of the fluid sampling system 100 discussed above may be substantially achieved.

In some embodiments, the outlet portion 404 is formed in a substantially circular fashion with a short length. Accordingly, the outlet portion 404 may receive the mixing fluid (as accelerated by the taper portion 403), form the mixing fluid into a fluid column due to the dimensions of the outlet portion 404 (e.g., the mixing fluid is collimated by the dimensions of the outlet portion 404), and discharge the mixing fluid into the axial bore 122 of the main line 101. In some embodiments, collimation of the mixing fluid is advantageous for maximizing the agitation or mixing established by the discharge of the orifice 400 at any given pressure provided by the pump 103 (in other words, the velocity at which the mixing fluid enters the orifice 400). The outlet portion 404 may form a length L₂, which may be the same or different than an L₁ of the inlet portion 402. L₂ may be a generally short length in order to collimate the mixing fluid, while also limiting any additional flow length incurred by the outlet portion 404 that would otherwise contribute to additional force requirements associated with the pump 103. For example, L₂ may be five millimeters, six millimeters, or any other appropriate length required to collimate the mixing fluid for discharge. By collimating the mixing fluid, the discharge of the mixing fluid may be directed on a more focused (e.g., narrow, targeted, consistent, etc.) path as the mixing fluid is discharged from the discharge path of the orifice 400, in order to facilitate the fluid mixing disclosed herein.

In various implementations of the present disclosure, dimensions of the discharge path, such as D₁, D₂, L₁, L₂, L₃, and β may be determined to achieve the various advantages of the present disclosure discussed herein (e.g., reduced pressure drop across the pump 103, the fluid column discharge, orifice orientation to achieve advantageous fluid mixing, etc.) in conjunction with the various dimensions of the other components in the fluid sampling system 100. For example, various implementations of the present disclosure may feature varying sizes of the main line 101, the nozzle 104, and so on. As such, the various dimensions discussed herein are merely presented as illustrative examples of particular embodiments of the present disclosure and should not be read as limiting.

Referring now to FIG. 5, a cross-sectional view of the orifice 400 is shown, according to some embodiments. As depicted, the orifice 400 is disposed within the orifice pad 401 at an angle ϕ relative to a surface of the orifice pad 401 that interfaces with the axial bore 122. In some embodiments, when the orifice 400 is disposed within the orifice pad 401 (and the nozzle body 201 by extension) at an angle such as ϕ, the lengths of the inlet portion 402 and the outlet portion 404 may vary about their circumference. For example, when the orifice 400 is disposed at angle ϕ, the outlet portion 404 may form an upper length L5 and a lower length L6 to facilitate angle of the outlet portion 404 while also maintaining a substantially flush interface with the surface of the orifice pad 401 that interfaces with the axial bore 122. The inlet portion 402 may have similar variations in dimensions in order to facilitate such a flush interface with a surface of the orifice pad 401 that interfaces with the axial bore 207.

Referring now to FIG. 6, a wall-based fluid mixing system 501 is shown, according to some embodiments. In some embodiments, the system 501 may be included in the fluid sampling system 100. In other words, the system 501 may be included in the fluid sampling system 100 in addition to the fluid mixing system described in reference to the nozzle 104. In other embodiments, the system 501 may substantially replace the nozzle 104 in the fluid sampling system 100 for performing the fluid mixing disclosed herein. For example, the system 501 may be fluidly coupled to the second pipe segment 107 via an inlet tap 504, secured by a flange 505. As mixing fluid is provided to the inlet tap 504 from the second pipe segment 107, the mixing fluid flows through a cavity 503 enclosed by a portion of the pipe wall 121 and a sleeve 502. In some embodiments, the cavity 503 and the sleeve 502 may extend about an entire cross-sectional circumference of a portion of the pipe wall 121. The mixing fluid may fill the cavity 503 such that the mixing fluid is discharged from the one or more orifices 506 disposed within the portion of the pipe wall 121 that is surrounded by the cavity 503 and the sleeve 502. The orifices 506 may be substantially similar to the orifices 213, 214, and/or 215 depicted in FIGS. 2 and 3, or the orifice 400 depicted in FIGS. 4 and 5. In some embodiments, and as shown, the orifices 506 are generally directed toward the inlet 110 of the main line 101 and, accordingly, against the flow of the resource fluid flowing through the main line 101. As shown, the orifices 506 may be axially aligned with one another. In other words, the orifices 506 may be located at the same axial distance from the inlet 110, although they are arranged at differing circumferential points about the pipe wall 121. In this sense, the mixing fluid discharged by the orifices 506 may enter the axial bore 122 at the same axial location along the main line 101. In other embodiments, the orifices 506 are arranged at varying axial locations relative to one another (e.g., the orifices 506 are not axially aligned). While the orifices 506 are shown as including three orifices, less or more orifices may be included in the orifices 506. For example, in some embodiments, the orifices 506 may include a single orifice, while in other embodiments, the orifices 506 may include five orifices. Accordingly, the orifices 506 are depicted to include three orifices merely by way of example, and more or less orifices may be included, depending on the implementation.

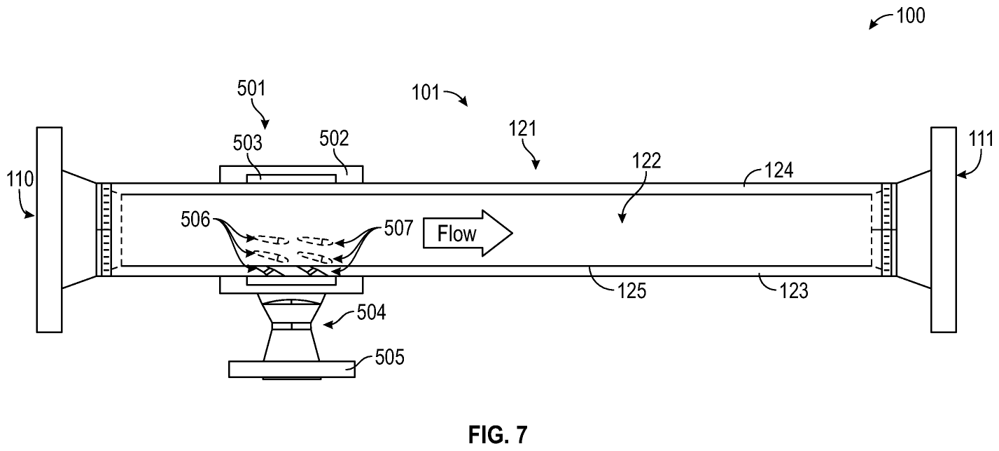

Referring now to FIG. 7, the system 501 is shown with two sets of parallel orifices, according to some embodiments. Accordingly, in some embodiments, the system 501 may include a first set of orifices (shown as the orifices 506) and a second set of orifices (shown as orifices 507) offset from one another relative to the direction of fluid flow through the main line 101. In some embodiments, and as shown, the orifices 507 may be disposed within the pipe wall 121 such the orifices 507 are generally directed toward the inlet 110, at substantially the same angle as the orifices 506. In other words, the angles of the orifices 506 and 507 may be equal in magnitude, but differ in direction with respect to a particular location with respect to a point along the main line 101. In other embodiments, the orifices 507 may be disposed within the pipe wall 121 such that the orifices 507, while still generally directed toward the inlet 110, are at a different angle than the orifices 506.

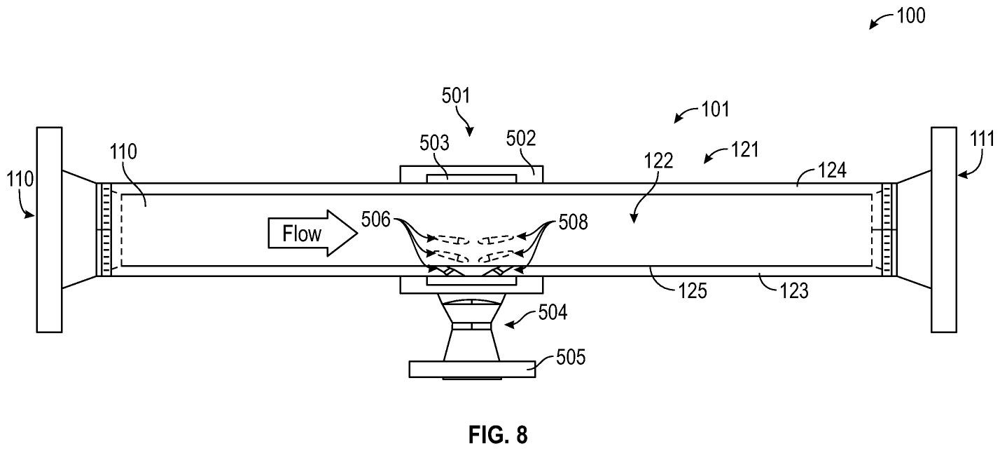

Referring now to FIG. 8, the system 501 is shown with two sets of bi-directional orifices, according to some embodiments. In some embodiments, the system 501 includes a first set of orifices generally directed toward the inlet 110 (shown as the orifices 506) and a second set of orifices generally directed toward the outlet 111 (shown as orifices 508).

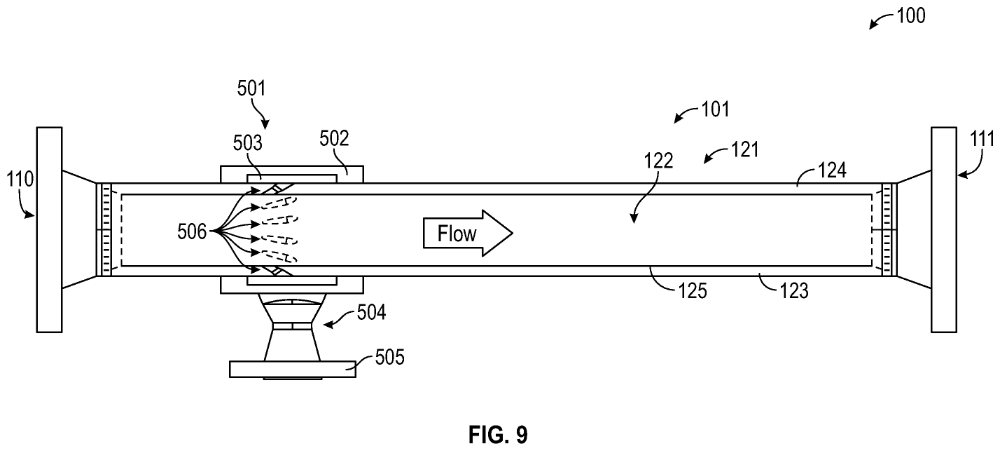

Referring now to FIG. 9, the system 501 is shown with a ring of orifices, according to some embodiments. In some embodiments, the orifices 506 may be disposed within the pipe wall 121 such that the orifices 506 are distributed about a cross-sectional circumference of the pipe wall 121, thereby forming a substantially evenly distributed ring.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (i.e., permanent or fixed) or moveable (i.e., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (i.e., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fluid mixing device for a pipeline, the pipeline comprising a pipe wall and a first axial bore that extends from an inlet of the pipeline to an outlet of the pipeline for conveying a pipeline fluid through the pipeline from the inlet to the outlet, the fluid mixing device comprising a fluid source operable to supply a mixing fluid to the axial bore through one or more orifices fluidly coupled to the fluid source, the one or more orifices comprising a first orifice, the first orifice comprising:
an intake portion operable to receive the mixing fluid and defining a first interior diameter;
a discharge portion operable to discharge the mixing fluid and defining a second interior diameter smaller than the first interior diameter; and
a taper portion intermediate the intake portion and the outlet portion.

2. The fluid mixing device of claim 1, wherein the taper portion defines a third internal diameter, the third internal diameter decreasing from a first end of the taper portion coupled to the intake portion and a second end of the taper portion coupled to the discharge portion.

3. The fluid mixing device of claim 1, wherein a flow of the mixing fluid is accelerated along a first end of the taper portion coupled to the intake portion and a second end of the taper portion coupled to the discharge portion.

4. The fluid mixing device of claim 1, wherein the discharge portion forms an annular bore extending from a first end of the discharge portion coupled to the taper portion and a second end fluidly coupled to the axial bore, such that a flow of mixing fluid is discharged into the axial bore in a fluid column.

5. The fluid mixing device of claim 1, wherein the fluid mixing device further comprises a nozzle intermediate the fluid source and the one or more orifices, the nozzle extending through the pipe wall and at least partially into the axial bore, the nozzle comprising a nozzle wall and a nozzle inlet fluidly coupled to the fluid source, the nozzle wall enclosing a nozzle bore in fluid communication with the nozzle inlet, wherein the first orifice is disposed within a portion of the nozzle wall that is within the axial bore, such that the nozzle bore and the axial bore are in fluid communication via the first orifice.

6. The fluid mixing device of claim 5, wherein the first orifice is positioned on the nozzle wall toward the inlet of the pipeline, such that the mixing fluid is discharged against the flow of the pipeline fluid.

7. The fluid mixing device of claim 5, wherein the first orifice is angled through the nozzle wall toward a bottom of the pipe wall.

8. The fluid mixing device of claim 1, wherein the fluid mixing device further comprises a sleeve disposed about the pipe and a cavity provided between an exterior surface of the pipe and an interior surface of the sleeve, wherein the first orifice is disposed within the pipe wall, such that the cavity and the axial bore are in fluid communication via the first orifice.

9. The fluid mixing device of claim 8, wherein the first orifice is angled through the pipe wall toward the inlet, such that the mixing fluid is discharged against the flow of the pipeline fluid.

10. An apparatus comprising a conduit having a bore for conveying a multiphase fluid extending from an inlet of the conduit to an outlet of the conduit, an external pump, and a hollow annular insert extending at least partially into the conduit, the hollow annular insert comprising an insert wall enclosing a insert bore in fluid communication with an insert inlet, and a plurality of ducts disposed within the insert wall, such that the insert bore is in fluid communication with the conduit via the plurality of ducts, the plurality of ducts each comprising:
an intake portion operable to receive a process fluid from the insert bore and defining a first interior diameter;
a discharge portion operable to discharge the process fluid and defining an annular bore forming a second interior diameter smaller than the first interior diameter, wherein the annular bore is operable to form a flow of the process fluid into a fluid column; and
a taper portion intermediate the intake portion and the discharge portion, the taper portion defining a third internal diameter decreasing from a first end of the taper portion coupled to the intake portion to a second end of the taper portion coupled to the discharge portion, such that the flow of the process fluid is accelerated between the intake portion and the discharge portion.

11. The apparatus of claim 10, wherein:
the hollow insert extends vertically into the conduit;
the insert bore forms a vertical central axis;
the plurality of ducts comprises a first set of ducts, a second set of ducts, and a third set of ducts;
the first set of ducts are arranged in a first vertical series parallel to the vertical axis and facing the inlet of the conduit;
the second set of ducts are arranged in a second vertical series parallel to the vertical axis and circumferentially offset from the first vertical series by a first circumferential distance in a first circumferential direction; and
the third set of ducts are arranged in a third vertical series parallel to the vertical axis and circumferentially offset from the first vertical series by a second circumferential distance in a second circumferential direction opposite the first circumferential direction

12. The apparatus of claim 11, wherein the first circumferential distance and the second circumferential distance are the same.

13. The apparatus of claim 11, wherein the second set of ducts and the third set of ducts are each offset from the first set of ducts such that the second set of ducts and third set of ducts are closer to the inlet of the conduit than the outlet of the conduit.

14. The apparatus of claim 11, wherein:
the first set of ducts are angled through the insert wall toward a bottom of the conduit;
the second set of ducts are angled through the insert wall toward a top of the conduit; and
the third set of ducts are angled through the insert wall toward the top of the conduit.

15. A method, comprising:
routing a multiphase fluid into a pipe of a fluid mixing device, the pipe having a pipe wall and an axial bore that extends from an inlet of the pipe to an outlet of the pipe for conveying the multiphase fluid through the pipe from the inlet of the pipe to the outlet of the pipe, wherein the fluid mixing device further comprises a sleeve disposed about the pipe, a cavity provided between an exterior surface of the pipe and an interior surface of the sleeve, wherein the cavity and the axial bore of the pipe are in fluid communication with one another via a plurality of openings through the pipe wall, and the plurality of openings through the pipe wall are located between the inlet of the pipe and the outlet of the pipe, the plurality of openings each comprising:
an intake portion operable to receive a mixing fluid from the cavity and defining a first interior diameter,
a discharge portion defining an annular bore forming a second interior diameter smaller than the first interior diameter, wherein the annular bore is operable to form a flow of the external fluid into a fluid column, and
a taper portion intermediate the intake portion and the discharge portion, the taper portion defining a third internal diameter decreasing from a first end of the taper portion coupled to the intake portion to a second end of the taper portion coupled to the discharge portion, such that the flow of the external fluid is accelerated between the intake portion and the discharge portion;
routing the mixing fluid into through the cavity and into the intake portions of the plurality of openings via an external pump fluidly coupled to an inlet of the cavity; and
jetting the mixing fluid directly into the pipe via the discharge portions of the plurality of openings to mix components of the multiphase fluid with one another, wherein the mixing fluid is accelerated along the taper portion and formed into a fluid column by the annular bore of the discharge portion.

16. The method of claim 15, wherein a first one or more openings of the plurality of openings are axially offset relative to the axial bore from a second one or more openings of the plurality of openings.

17. The method of claim 15, wherein the plurality of openings are angled through the pipe wall.

18. The method of claim 17, wherein a first one or more openings of the plurality of openings are angled toward the direction of flow through the axial bore and a second one or more openings of the plurality of openings are angled away from the direction of flow through the axial bore.

19. The method of claim 18, wherein the second one or more openings are axially offset relative to the axial bore from the first one or more openings.

20. The method of claim 19, wherein the second one or more openings are closer to the inlet than the first one or more openings.
